(19) United States
(12) Patent Application Publication
(10) Pub. No.: US 2013/0060456 A1
(43) Pub. Date: Mar. 7, 2013

(54) Synchronizing car movements in road to reduce traffic

(71) Applicant: Peyman Pourparhizkar, Toronto (CA)

(72) Inventor: Peyman Pourparhizkar, Toronto (CA)

(21) Appl. No.: 13/204,675

(22) Filed: Sep. 2, 2011

(51) Int. Cl. G08G 1/00

(52) U.S. Cl. 701/117

(57) ABSTRACT

This invention describes a method (System requirements for Car Movement Control System, 1-10) to improve traffic by coordinating the car movements. This algorithm can be implemented using an embedded software that runs on especial computerized device installed on a car. The car should have already been utilized with an “Adaptive cruise control system” (Computerized system that allows a car to move with a fixed speed and can adjust car speed to avoid collision when required) or “Automatic car navigation system” (Computerized system that allows a car move from source to destination automatically without driver intervention using GPS or road transponders).

### CROSS-REFERENCE TO RELATED APPLICATIONS

It is assumed that the following technologies are already available. This patent will improve these technologies:
Adaptive cruise control technology
Patent numbers for “Adaptive cruise control technology”:

| | | | |
|---|---|---|---|
| 7,966,118 | 7,945,369 | 7,784,422 | 7,753,153 |
| 7,739,023 | 7,650,217 | 7,457,699 | 7,346,994 |
| 7,337,055 | 7,260,465 | 7,197,390 | 7,136,013 |
| 7,121,011 | 7,096,109 | 7,054,733 | 6,985,805 |
| 6,968,266 | 6,911,794 | 6,882,923 | 6,856,887 |
| 6,823,601 | 6,795,765 | 6,785,611 | 6,778,897 |
| 6,769,504 | 6,748,312 | 6,708,100 | 6,708,099 |
| 6,687,595 | 6,678,603 | 6,622,810 | 6,580,996 |
| 6,560,525 | 6,502,034 | 6,470,257 | 6,374,174 |
| 6,374,173 | 6,370,470 | 6,304,808 | 6,233,515 |
| 6,223,117 | 6,116,369 | 6,009,368 | 5,454,442 |
| 4,987,357 | | | |

Automatic car navigation technology
U.S. Pat. No. 7,031,829
Wireless car to car communication
(Patent number not found)

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This is a new invention and as I searched the patent database I didn't find something similar to it. Although “Wireless car to car communication”, “Automatic Car Navigation System (computerized)” or “Adaptive Car Cruise Control System (computerized)” technologies are used in this invention but this invention is NOT a new type of “Automatic Car Navigation System” or “Adaptive Car Cruise Control System”. An important difference between this invention and “Adaptive Car Cruise Control System” is that in “Adaptive Car Cruise Control System” there are usually two cars involved (host car and target car) but this invention explains a new method in which several cars can follow (be synchronized with) one car (leader car). See “BRIEF SUMMARY OF THE INVENTION” for more details. Although the explained method (See: SYSTEM REQUIREMENTS FOR CAR MOVEMENT CONTROL SYSTEM 1-10) is very high level and doesn't have all the details, I believe it can still be considered as a new invention for which a patent can be granted considering the uniqueness of the method that never been tested/implemented before.

### BRIEF SUMMARY OF THE INVENTION

This invention describes a method (See “System requirements for Car Movement Control System (1-10)”) to improve traffic by coordinating car movement with a leader car in front when traffic occurs. This high level algorithm can be implemented by a computerized device that is installed on a car. It is explained how to force the movements of a great number of cars to be highly synchronized such that those cars look like to be connected in a virtual train. Eventually it is explained how this synchronization method can be implemented using a computerized device. This invention is based on “Wireless car to car communication”, “Automatic Car Navigation System (computerized)” or “Adaptive Car Cruse Control System (computerized)”.

### BRIEF DESCRIPTION OF THE SEVERAL VIEWS OF THE DRAWING

FIG. 1: Explains how this invention can be implemented using “Automatic Car Navigation System”. This picture describes the hardware that is needed for “Implementation requirements—A”

FIG. 2: Explains how this invention can be implemented using “Adaptive Cruise Control System”. This picture describes the hardware that is needed for “Methods of implementation—B”

### DETAILED DESCRIPTION OF THE INVENTION

### Introduction

One of the main reasons that the roads are congested in rush hours is that there are many cars that are not moving synchronously. If we were able to force car movements in roads to be highly synchronized, i.e. a great number of cars move and stop simultaneously (exactly at the same time and with same speed), highway traffic congestion would be reduced. The car movement synchronization should be done with such accuracy that a great number of cars move like they are connected in a virtual train.

A good example that proves the usefulness of this idea is the cars that are stopped behind a red light. Assume that several cars are stopped behind a red light and the light is changed to green. It is a long delay for the cars that are behind to start moving. But if the cars are connected like a virtual train, all the stop cars behind the red light will start moving simultaneously.

We can achieve car movement synchronization by virtually connecting the cars using car to car wireless communication

To implement this idea we need to use an automatic car navigation technology. For this design, I assume that the “automatic car navigation” or “adaptive cruise control technology” are already available i.e. each car can move from source to destination automatically using GPS (or road transponder) technology and using an image processing technology that can detect and react to road obstructions. Now assume 100 cars with this technology are moving in a road. Whenever the car in front detects an obstruction such that it cannot move with the current road/highway maximum speed, it sends its current speed and acceleration to the cars that are moving behind. Each car that is moving behind will use this information to reproduce the exact acceleration or deceleration and speed at the same time. Hence all the cars that are behind will move exactly at the same time and with the same acceleration as the front car.

### System Requirements for Car Movement Control System (1-10):

Let's call the car that is moving in front and is broadcasting the speed, acceleration information the leader car.
1) Each car (leader or not) should react to obstructions that are not moving with the same speed as the current high way speed by reducing the speed. Any car should react to the signal that is received from a red light by stopping. When the obstruction is removed (or light is changed to green) the car speed should be increased back to the current high way speed. The automatic car navigation technology or adaptive cruise control technology are used here to react to obstructions (See 10).
2) Any car that cannot move with the same speed as the current road/highway speed (should reduce speed because of an obstruction or a red light, see 1) and is NOT behind a leader car should become a leader car by starting to send its speed, acceleration and position to the cars that are moving behind using wireless car to car communication. A car that has disengaged the “Automatic Car Navigation System” or “Adaptive Cruise Control System” cannot be a leader car. This prevents the car that is run by a driver and is moving randomly force the cars behind it to move randomly a leader car only follows the commands of “Automatic Car Navigation System” or “Adaptive Cruise Control System” and broad casts its signal to the cars that are following it.
3) Any car that cannot move with the current road/highway speed (because of an obstruction, see 1) and is behind leader car(s), will use acceleration and speed information from the leader car to reproduce the same speed and acceleration at the same time. Hence it becomes synchronized with the leader car. This car will choose the car that is closest and is moving in the same path as a leader car and will try to mimic the speed and acceleration. (Considering the car position and the position information in the signal, each car can determine whether the signal is coming from a car that is moving in front or behind and how far the car is).
4) If a car that was following a leader car cannot mimic the leader car speed and acceleration any more for any reason (internal issues or external obstructions causing speed reduction or obstruction speed is higher that the speed of leader car) that car will become a new leader car to guide the cars that are moving behind it (See 10). When the leader car determines that it can follow the same speed and acceleration of another leader car that is in front it (for example because the car in front is moving with the same speed as the leader car again) will stop broadcasting the signal (stops to be a leader car) and will follow the leader car again (See 2, 10).
5) When obstruction for the leader car is removed such that it can move again with the same speed as the current road/highway maximum speed (and as a result the following cars will also move with the current road speed at the same time since they are following the leader car), the leader car will stop sending signals to the cars behind. This will reduce the number of wireless messages that are sent between cars. Similarly when a car that follows a leader car can move with the same speed of road/highway again it will stop following the leader car (ignores the leader car), these cars become free moving again independent of each other and will only follow the commands of “Automatic Car Navigation System” or “Adaptive Cruise Control System” (See 10).
6) For each highway/road lane there should be a different leader car. Car in one lane cannot lead a car in different lane.
7) Each leader car can only lead the cars that are moving in the same path so if the leader car leaves that path (for example leaves the highway or breaks for any reason) the car behind it should take the lead and become a new leader car (Of course only when that car cannot move with the current road/highway speed). In general if any car loses a signal from leader car and cannot drive with the current highway speed, that car should become a new leader car itself.
8) Each leader car can lead up to ‘n’ cars behind it. If the distance between the leader and the car that is behind is more than the length of ‘n’ cars+gaps or the signal is too weak, that car should ignore the signal and become a leader itself ('n′ is TBD)
9) Each leader car should send the path and position information and the average speed (TBD) in that lane in addition to speed and acceleration to the cars that are behind.
10) The “Automatic Car Navigation System” or “Adaptive Cruise Control System” should be adjusted such that they do not override the acceleration, deceleration commands of the “Car Movement Control System” as much as possible (“Car Movement Control System” is a computerized hardware/software module that implements this algorithm, see “Methods of implementation”). Only when possibility of accident is eminent, the “Automatic Car Navigation System” or “Adaptive Cruise Control System” should intervene to avoid collision. This can be verified by comparing the speed of the current car and the car that is moving in front. If the two speeds are too different or distance to front car is too short, the “Automatic Car Navigation System” or “Adaptive Cruise Control System” should reduce the speed of car (ignoring leader car speed temporarily) to avoid collision. Similarly if the car in front is moving faster than leader car the current car should still follow the same speed of the leader car until the speed difference is too much or the distance to the front car is too big in which case the current car will speed up (ignoring leader car speed temporarily) to catch the front car. If the situation of different speeds happens several times, the car should become a leader car (see 4 above).

### Extra Explanations for “System Requirements 1-10”:

Note that as explained before, the automatic car navigation technology (or adaptive cruise control technology) should have already been implemented. So if the car that is using the signal of a front leader car determines that there is an obstruction in front of it that is moving slower than the leader car, should be able to react automatically to that obstruction to avoid collision (See 1, 10). So for example if there is a car in front that is not utilized with this technology and that car slams on brake, the behind car should be able to stop immediately (ignoring the leader car temporary).

For this system to work efficiently, it is important that most of the cars can follow the speed and acceleration of the leader car with a great accuracy. As a result, most of the cars will follow the leader car without the need to be a leader car themselves.

In order to achieve this, a sophisticated automatic speed control system must be installed in each car. The speed control system should be adaptable to the car type and model to be able to determine exactly how much gas pedal or brake pedal pressure is needed to gain necessary acceleration or deceleration. An accurate error detection and correction should be used to adjust the speed and acceleration by comparing the expected and the real speed/acceleration.

How Signal should be Broadcasted:

To send the car information signal the same technology that is used by cell phones is used; there are a few frequencies that can be reused. A leader car can send its information on the same frequency of another leader car as long as the leader cars are far enough.

The car information signal is send for example every 1 second by the leader car to maintain the communication. Every time that speed, acceleration or path information of the leader car is changed, the signal should be resent immediately to make sure that the following cars would react to it immediately.

### Methods of Implementation:

### A) How the System Requirements for Car Movement Control System (1-10) can be Implemented Using “Automatic Car Navigation” Technology (1-7):

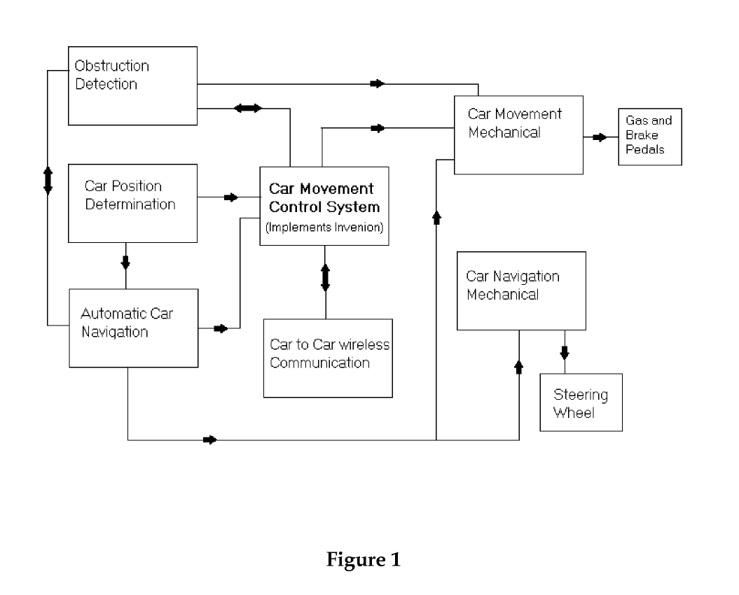

Assuming that “automatic car navigation” technology and “wireless car to car communication” technology already exist (Module numbers 1, 2, 3, 4, 5), especial computerized device should be build that contains the following modules (FIG. 1):
1) “Obstruction Detection System” (Using picture processing, sonic radar, . . . )
2) “Car Position Determination System” (using GPS, Road transponders, . . . )
3) “Automatic Car Navigation System” that works based on “Car Position determination system” and uses a digital map to determine when the car should turn left or right.
4) “Car Navigation Mechanical System” that is connected to car steering system is commanded by “Automatic Car Navigation System”.
5) “Car to Car wireless Communication System”.
6) “Car Movement Control System” that implements “System requirements for Car Movement Control System (1-10)” and uses “Car to Car Communication System” to determine the amount of acceleration or deceleration that is needed (received from leader car) and cooperates with “Automatic Car Navigation System” and “Obstruction Detection System” to command the “Car Movement Mechanical System” (number 7) as described in “System requirements for Car Movement Control System (10)”. In a leader car only “Automatic Car Navigation System” and “Obstruction Detection System” command the “Car Movement Mechanical System”.
7) “Car Movement Mechanical System” that is connected to the car gas, brake pedals to control the car acceleration, deceleration and is commanded by “Car Movement Control System”, “Automatic Car Navigation System” and “Obstruction Detection System”.

In the above modules the “Car Movement Control System” (6) is the new module that implements the “System requirements for Car Movement Control System (1-10)” described before (Subject of invention).

This hardware should be installed on a car and fine-tuned to make sure the right amount of gas pedal, or brake pedal pressure is applied to reach the desired standardized acceleration, deceleration. (Considering the feedback system that is part of Car Movement Control System, any error in acceleration or deceleration should be compensated immediately. But the above fine tuning is still necessary to reduce the default error as much as possible)

B) How this Design can be Implemented Using “Adaptive Cruise Control” Technology (I-III and 1-4):

With adaptive cruise control technology the implementation of “Car Movement Control System” module (See (A)—6 above) is simpler. Except that there are a couple of challenges. Adaptive cruise control technology doesn't use the GPS or road transponder so the leader car cannot be chosen using the position information. In this case the Leader can be found using three additional data (I, II, III):
I) Leader Car direction is determined using a digital compass and broadcasting the car moving direction that is obtained from compass. The compass direction of the current car that follows the leader car should be the same as (or almost the same as) the Leader Car compass direction (that is broadcasted).
II) Leader Car speed and acceleration should be the same as (or almost the same as) the speed and acceleration of the car that is in front of the current car (adaptive cruise control system should be able to determine the speed and acceleration of the car that is moving in front and has caused the obstruction)
III) If there are several leader cars with the same speed, acceleration and moving direction the leader car with the stronger signal is selected.

Using the above information, each car should be able to find the leader car from several leader cars that are moving around.

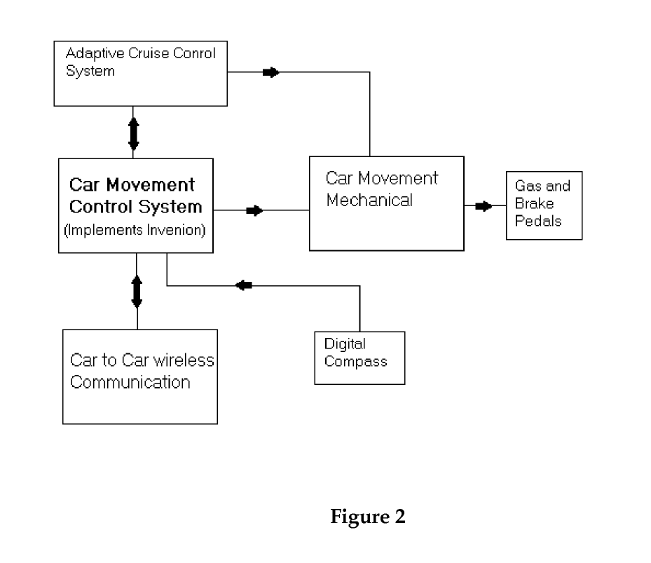

So using the “adaptive cruise control” and “wireless car to car communication” technologies (Module numbers 1, 3), especial computerized device should be build that contains the following modules (Modules 1-4, FIG. 2):
1) “Adaptive cruise control” system.
2) “Car Movement Control System” that implements “System requirements for Car Movement Control System (1-10)” and uses “Car to Car Communication System” to determine the amount of acceleration or deceleration that is needed (received from leader car) and cooperates with “adaptive cruise control” to commands the “Car Movement Mechanical System” (number 4) as described in “System requirements for Car Movement Control System—10”. In a leader car only “Adaptive Cruise Control System” commands the “Car Movement Mechanical System”.
3) “Car to Car wireless Communication System”
4) “Car Movement Mechanical System” that is connected to the car gas, brake pedals to control the car acceleration, deceleration and is commanded by Car Movement Control System (number 6) and car “adaptive cruise control” (number 1).

What is claimed is:

1) “System requirements for Car Movement Control System (1-10)” describes a high level algorithm (or method) to coordinate car movement using wireless car to car communication and computerized device in roads/highways in order to reduce traffic when the chance of heavy traffic is high. This System Requirements (high level algorithm) can be implemented by a computerized device. This algorithm is based on “Car to car wireless communication”, “Adaptive cruise control system” or “Automatic car navigation system” technologies that pre-exist. “Extra explanations for System requirements 1-10” gives extra explanation for “System requirements for Car Movement Control System (1-10)” to clarify it more.

2) “Methods of implementation” (‘A’ and ‘B’) and FIGS. 1 and 2, are high level requirements that describes how the algorithm in claim 1 can be implemented using “Car to car wireless communication”, “Adaptive cruise control system” or “Automatic car navigation system” technologies and using a new hardware/software module called “Car Movement Control System”.

3) “How signals should be broadcasted” describes a method that that is based on “Car to car wireless communication” to broadcast signals by leader car. Claims 1, 2 use this method for “Car to car wireless communication”.
